(19) United States
(12) Patent Application Publication
(10) Pub. No.: US 2010/0143067 A1
(43) Pub. Date: Jun. 10, 2010

(54) ANCHOR BOLT AND METHOD FOR MAKING SAME

(75) Inventor: PAUL GAUDRON, Stratford, CT (US)

Correspondence Address: CANTOR COLBURN, LLP, 20 Church Street, 22nd Floor, Hartford, CT, 06103, US

(73) Assignee: POWERS FASTENERS, INC., Brewster, NY (US)

(21) Appl. No.: 12/263,929

(22) Filed: Nov. 3, 2008

(51) Int. Cl. F16B 29/00; F16B 13/06

(52) U.S. Cl. 411/354; 411/59

(57) ABSTRACT

Discloses is an anchor bolt including a stud. The anchor bolt further includes a wedge in operable communication with the stud. The anchor bolt still further includes a heat treated then cold worked sleeve disposed about the stud and in operable communication with the wedge.

### BACKGROUND

An anchor bolt is typically used to attach objects or structures to a base material. The general components of an anchor bolt are a stud, a wedge and a sleeve portion. In use, a hole is drilled or otherwise formed in the base material that has a diameter only slightly larger than that of the wedge and the sleeve of the anchor bolt. This allows passage of the wedge and the sleeve of the anchor bolt into the hole. Upon expansion of the sleeve, however, the material thickness of the sleeve is interposed between the wedge and the base material. This effectively increases the diameter of the wedge by roughly twice the thickness of the sleeve. Since the hole diameter in the base material does not change appreciably due to the expansion input, the anchor bolt becomes substantially permanently anchored in the base material.

Both function and longevity of such anchor bolts in large part rely on the properties of the sleeve portion. More specifically the material must be durable enough and durable enough to provide suitable anchoring capability and reasonable life. Heretofore, the only material deemed acceptable by the art has been stainless steel material. While this material is quite appropriate for the task its cost factor is difficult to absorb. Since economic considerations are important in nearly all industries, the art is always receptive to alternative configurations.

### SUMMARY OF THE INVENTION

According to one aspect of the invention, an anchor bolt includes a stud and a wedge in operable communication with the stud. The anchor bolt further includes a heat treated then cold worked sleeve disposed about the stud and in operable communication with the wedge.

According to another aspect of the invention, an anchor bolt includes a stud and a wedge in operable communication with the stud. The anchor bolt further includes a low carbon steel sleeve disposed about the stud and in operable communication with the wedge.

According to yet another aspect of the invention, a method for manufacturing an anchor bolt sleeve includes heat treating a steel blank, and cold working the steel blank into an anchor bolt sleeve subsequent to the heat treating, the anchor bolt sleeve being expandably receptive to a wedge of an anchor bolt.

### BRIEF DESCRIPTION OF THE FIGURES

The following descriptions should not be considered limiting in any way. With reference to the accompanying drawings, like elements are numbered alike:

FIG. 1 depicts a side view of an anchor bolt according to an embodiment of the present invention;

FIG. 2 depicts a perspective view of a steel blank disclosed herein; and

FIG. 3 depicts a perspective view of a fully formed sleeve disclosed herein.

### DETAILED DESCRIPTION

A detailed description of the hereinafter described embodiments of the disclosed apparatus and method are presented herein by way of exemplification and not limitation with reference to the Figures.

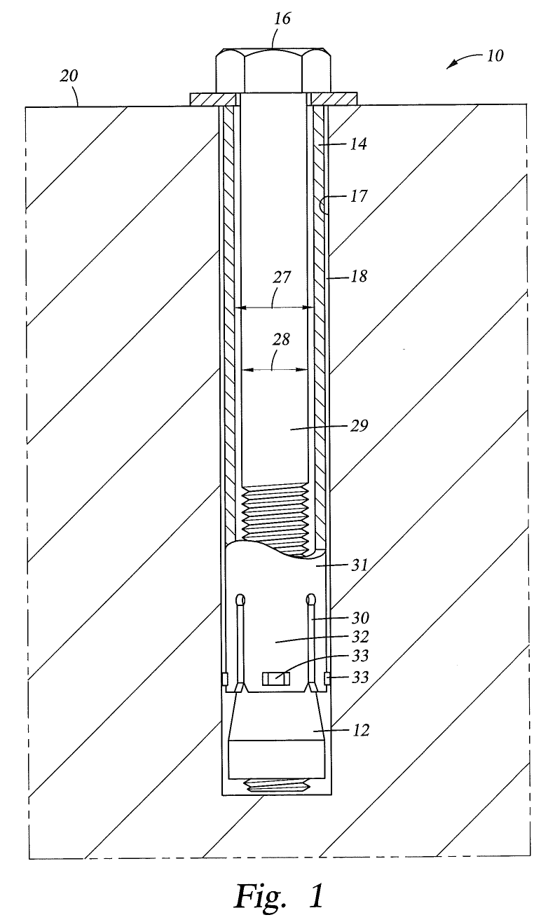

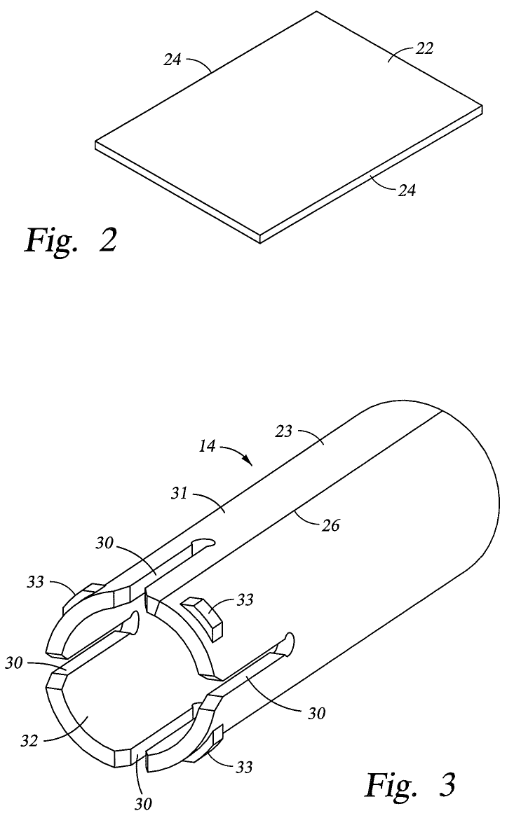

Referring to FIGS. 1-3, an embodiment of an anchor bolt 10 disclosed herein is shown. The anchor bolt 10 includes, a wedge 12, a sleeve 14 and a stud 16. The wedge 12 is threadably engaged with the stud 16 such that rotation of the stud 16 relative to the wedge 12 causes the wedge 12 to move axially along the stud 16. This axial movement of the wedge 12 causes the wedge 12 to also move axially relative to the sleeve 14 thereby causing radial expansion of the sleeve 14. The radial expansion of the sleeve 14 results in a frictional engagement between the sleeve 14 and walls 17 of a hole 18 in a work piece 20 to which the anchor bolt 10 is being attached. It should be understood that the anchor bolt 10 is not limited to this configuration, but may include any configuration having a wedge and a sleeve. As disclosed herein, prior to its formation, the sleeve 14 is a steel blank 22 that is first hardened with at least one heat treatment technique. Thereafter, a cold work process is used to further harden the sleeve 14 and finish forming the sleeve 14 into its final configuration. In the embodiments disclosed herein the cold work process includes rolling the steel blank 22 into a hollow cylindrical shape 23 as shown in FIG. 3. The hollow cylindrical shape 23 shows two adjacent sides 24 of the steel blank 22 joined along an axial seam 26 in the finished sleeve 14.

The steel blank 22 is made of one or more of a low carbon steel and a high strength, low alloy (HSLA) steel. A low carbon steel has less than about 0.25% by weight carbon whereas a HSLA steel has elements such as copper, vanadium, nickel, and molybdenum in combined concentrations as high as about 10% by weight. Thus, the steel blank 22 is composed of a material that is cold workable after being hardened.

Hardening of the steel blank 22 is accomplished with at least one heat treatment process. In one embodiment, the steel blank 22 is quenched and tempered. Quenching and tempering results in at least one of a stronger and harder steel blank 22, or any combination thereof that is favorable in durability, vibration resistance, load capacity, etc. In one embodiment, the heat treatment results in a steel blank 22 having a Rockwell C hardness of less than 35. This allows the steel blank 22 to be more easily formed by a cold working process.

Forming the steel blank 22 into hollow cylindrical shape 23 of the sleeve 14 includes a cold working process, such as, rolling, drawing, pressing, spinning, extruding, for example, or any other process that produces a desirable sleeve shape. In addition to forming the steel blank 22 into hollow cylindrical shape 23, the cold working process also increases a strength and hardness of the sleeve 14 in the process. The cold working process may result in a steel blank having a hardness greater than 35 on the Rockwell C hardness scale. Furthermore, by cold working to the final hollow cylindrical shape 23 after heat treating, embodiments disclosed herein prevent the seam 26 from opening up during heat treating as would likely occur had the heat treating been performed after the forming to the final hollow cylindrical shape 23.

Sizing of the sleeve 14 into the final hollow cylindrical shape 23 is important to the proper operation of the anchor bolt 10. The sleeve 14 is sized to be expandably receptive to the wedge 12 during setting of the anchor bolt 10. In the embodiment shown, the sleeve 14 has an inner diameter 27 that is greater than an outer diameter 28 of a shank 29 of the stud 16. As such, the shank 29 is free to rotate within the sleeve 14 before and during setting.

Exapandability of the sleeve 14 about the wedge 12 is facilitated by formation of at least one longitudinal opening 30, illustrated herein as a slot, in a wall 31 of the sleeve 14. The slot(s) 30 can be formed in the sleeve 14 at the formation of the blank 22 or during the formation of the final cylindrical shape 23. The slot(s) 30 allow a portion 32 of the sleeve 14 to be radially deflected without the necessity of stretching the material of the sleeve 14 or opening up the seam 26. In other embodiments, the sleeve may be configured for being stretched. Additional features may also be formed in the sleeve 14. For example, gripping projections 33 may be introduced on the sleeve 14 either during or prior to formation of the sleeve 14. The gripping projections 33 can increase friction between the base material and the sleeve 14 during setting of the anchor bolt 10. The gripping projections 33 are shown oriented in a latitudinal direction but may also be a longitudinal projection or may have a non-axial shape.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the claims.

What is claimed is:

1. An anchor bolt comprising:
a stud;
a wedge in operable communication with the stud; and
a heat treated then cold worked sleeve disposed about the stud and in operable communication with the wedge.

2. The anchor bolt of claim 1, wherein the heat treated then cold worked sleeve comprises a low carbon steel.

3. The anchor bolt of claim 1, wherein the heat treated then cold worked sleeve comprises a high strength, low alloy steel.

4. The anchor bolt of claim 1, wherein hardness of the heat treated then cold worked sleeve is increased due to the heat treating.

5. The anchor bolt of claim 1, wherein the heat treated then cold worked sleeve includes at least one longitudinal slot.

6. The anchor bolt of claim 1, wherein the heat treated then cold worked sleeve includes at least one gripping projection.

7. An anchor bolt comprising:
a stud;
a wedge in operable communication with the stud; and
a low carbon steel sleeve disposed about the stud and in operable communication with the wedge.

8. The anchor bolt of claim 7, wherein the low carbon steel sleeve is heat treated then cold worked.

9. The anchor bolt of claim 7, wherein the low carbon steel sleeve is quenched and tempered then cold worked.

10. The anchor bolt of claim 7, wherein the low carbon steel sleeve further comprises a high density low alloy steel.

11. The anchor bolt of claim 7, wherein the low carbon steel sleeve includes a longitudinal slot.

12. The anchor bolt of claim 7, wherein the low carbon steel sleeve includes a gripping projection.

13. A method for making an anchor bolt sleeve comprising:
heat treating a steel blank; and
cold working the steel blank into an anchor bolt sleeve subsequent to the heat treating, the anchor bolt sleeve being expandably receptive to a wedge of an anchor bolt.

14. The method for making an anchor bolt sleeve of claim 13, further comprising quenching and tempering the steel blank prior to the forming of the steel blank into the sleeve.

15. The method for machining an anchor bolt sleeve of claim 14, wherein the quenching and tempering results in hardening of the steel blank to a hardness not to exceed 35 on the Rockwell C hardness scale.

16. The method for machining an anchor bolt sleeve of claim 13, wherein the cold working results in hardening of the steel blank to a hardness greater than 35 on the Rockwell C hardness scale.

17. The method for machining an anchor bolt sleeve of claim 13, wherein the cold working is a process selected from the group consisting of rolling, drawing, pressing, spinning, extruding and heading.

18. The method for machining an anchor bolt sleeve of claim 13, wherein the cold working further includes joining the two adjacent sides of the steel blank along a seam.
